(19) United States
(12) Patent Application Publication
(10) Pub. No.: US 2025/0007007 A1
(43) Pub. Date: Jan. 2, 2025

(54) FORMATION OF PHOSPHORUS-RICH SOLID ELECTROLYTE INTERPHASE

(71) Applicant: The Regents of The University of California, Oakland, CA (US)

(72) Inventors: Juchen Guo, Anaheim, CA (US); Jian Zhang, Riverside, CA (US)

(21) Appl. No.: 18/711,567

(22) PCT Filed: Nov. 18, 2022
(86) PCT No.: PCT/US2022/050477

§ 371 Date: May 17, 2024

Related U.S. Application Data
(60) Provisional application No. 63/281,418, filed on Nov. 19, 2021.

(51) Int. Cl. H01M 10/42; H01M 10/0567

(52) U.S. Cl. CPC H01M 10/4235; H01M 10/0567; H01M 2300/0025

(57) ABSTRACT

Various examples disclosed relate to formation of phosphorous-rich solid electrolyte interphases in lithium metal batteries via phosphorous pentoxide additives. The present disclosure includes a battery cell including an anode comprising a lithium metal, a cathode, and an electrolyte with an additive. The electrolyte can include lithium hexafluorophosphate and the additive can include phosphorous pentoxide.

### CROSS-REFERENCE TO RELATED APPLICATION

This application claims the benefit of priority to U.S. Provisional Patent Application Ser. No. 63/281,418 entitled “FORMATION OF PHOSPHORUS—RICH SOLID ELECTROLYTE INTERPHASE IN LI METAL BATTERIES VIA PHOSPHORUS PENTOXIDE ADDITIVE,” filed Nov. 19, 2021, the disclosure of which is incorporated herein in its entirety by reference.

### STATEMENT OF GOVERNMENT SUPPORT

This invention was made with Government support under Grant No. CHE-1338173 awarded by National Science Foundation Major Research Instrumentation Program., and through Grant No. DMR-2011967 awarded by National Science Foundation to the UC Irvine Materials Research Science and Engineering Center. The U.S. Government has certain rights in this invention.

### TECHNICAL FIELD

This invention relates to battery cell devices and methods. In one example, this invention relates to lithium-ion batteries.

### BACKGROUND

Improved batteries, such as lithium metal batteries are desired. New materials and microstructures are desired to increase capacity, and to mitigate issues with electrolyte used in lithium metal batteries.

### SUMMARY OF THE DISCLOSURE

In an example, a battery cell includes an anode, a cathode, and an electrolyte. The anode comprises a lithium metal. The electrolyte includes an additive comprising phosphorous pentoxide (P₂O₅).

In an example, an electrolyte solution for a battery cell includes lithium hexafluorophosphate (LiPF₆) and phosphorous pentoxide (P₂O₅).

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various examples discussed in the present document.

FIGS. 1A and 113 depict ¹⁹F NMR spectra of the electrolyte in an example.

FIGS. 1C and 1D show corresponding SEM images of Li metal electrode after soaking in 1M LiPF₆ electrolyte in an example.

FIGS. 1E and 1F depict the corresponding F is XPS spectra and Li is XPS spectra to FIGS. 1A-1D in an example.

FIGS. 1G to 1J depict photographs of a pouch cell testing holder, a force sensitive resistor, an assembled testing holder, and a pressure loading calibration by a microcontroller in an example.

FIGS. 1K to 1N depict differential capacity (dQ/dV vs. voltage) plots comparing the commercial and P₂O₅-modified LiPF₆ electrolytes in an example.

FIGS. 2A to 2F depict SEM images of lithium deposited on lithium metal galvanostatically in an example.

FIG. 3A depicts an F is XPS spectra in an example.

FIG. 3B depicts a P 2p XPS spectra in an example.

FIG. 3C depicts the relative atomic percentage of F and P on Li metal foil after treatment in an example.

FIGS. 3D and 3E depict ¹⁹F single-pulse NMR measurements in the HF region in an example.

FIG. 4A depicts cycling performance of a Li∥NMC622 pouch cell in an example.

FIGS. 4B and 4C depict cell voltage profiles for a Li∥NMC622 pouch cell in LiPF₆ electrolyte.

FIGS. 5A to 5D depict dQ/dV vs. voltage plot of the comparison between LiPF₆ electrolyte without and with P₂O₅ additive in an example.

FIGS. 5E to 5F depict interface resistance and charge transfer resistance of the NMC622 cathode in a cell with LiPF₆ electrolyte without and with P₂O₅ additive in an example.

FIGS. 5G to 5I depict liquid-state through-bond correlation NMR measurements on the P₂O₅-modified LiPF₆ electrolyte in an example.

FIGS. 5J to 5L depict liquid-state single-pulse NMR measurements of the commercial and P₂O₅ modified LiPF₆ electrolyte in cells in an example.

FIG. 6A depicts EDS spectra of Li metal anode in an example.

FIGS. 6B to 6D depict FIB-SEM images corresponding to FIG. 6A in an example.

FIGS. 7A to 7C depict XPS spectra of the lithium metal surface after immersion in the commercial or P₂O₅ modified LiPF₆ electrolyte in an example.

FIGS. 8A to 8C depict EIS Nyquist plots performed at different rest times in Li∥Li symmetric cells in an example.

FIGS. 9A to 9C depict further C 1 s and O 1 s XPS spectra of the Li metal surface after galvanostatic deposition for 10 hours in commercial or P₂O₅-modified LiPF₆ electrolyte in an example.

FIG. 10A shows the representative Li deposition and stripping curves to measure the CE in an example.

FIG. 10B depicts the average CE of Li deposition-stripping measured from the pristine and P₂O₅-modified LiPF₆ electrolyte in an example.

FIG. 11 depicts SEM images in an example.

FIGS. 12A to 12F depict gas analysis using DEMS in an example.

FIG. 13 depicts an illustrative view of a lithium metal battery cell.

### DETAILED DESCRIPTION

Reference will now be made in detail to certain examples of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

The present disclosure provides methods and compositions for phosphorus rich solid electrolyte interphase formation in lithium metal batteries via phosphorous pentoxide additives in LiPF₆ electrolyte.

Discussed herein, phosphorus pentoxide (P₂O₅) can be an effective electrolyte additive to stabilize the electrolyte and electrode interphase, such as for lithium metal battery electrodes. P₂O₅ additives can enable uniform lithium deposition, in addition to mitigating transition metal dissolution and NMC622 particle cracking problems. The effectiveness of a P₂O₅ additive can be seen in the excellent performance of Li∥NMC622 battery pouch cells with realistic cell parameters and operating conditions. These discussed methods and compositions provide a variety of advantages, some of which are unexpected.

Lithium metal batteries, which can provide with high energy density, have become increasingly popular for a wide array of applications in various industries. Lithium metal batteries in particular may potentially be the next generation to conventional lithium-ion batteries. Despite their high energy density, lithium metal batteries face challenges of a short life cycle, and safety challenges, which have hindered commercialization.

Additionally, a suitable electrolyte for lithium metal batteries is desired. By comparison, lithium-ion batteries widely use LiPF₆ as an electrolyte, but this electrolyte is not compatible with lithium metal batteries. Specifically, the use of a LiPF₆ electrolyte in lithium metal batteries would cause an undesirable autocatalytic decomposition reaction, forming lithium fluoride and phosphorous pentafluoride. The subsequent hydrolysis process of phosphorous pentafluoride will react with trace amounts of moisture to form hydrofluoric acid. Such hydrofluoric acid can degrade electrode materials and electrolyte. For example, corrosive hydrofluoric acid can attack lithium metal and form corrosion pits.

In some cases, a highly resistive lithium fluoride passivation layer can form on the lithium metal anode, resulting in a non-uniform electrodeposition process. The decomposition of solid electrolyte interface (SEI) components on the anode and hydrofluoric acid can trigger continuous electrolyte decomposition. In addition, transition metal dissolution and cathode particle cracking can result from the presence of hydrofluoric acid.

Overall, many of these challenges derive from the hydrolysis reaction between decomposition products of LiPF₆ and PF₅ with moisture that forms hydrofluoric acid. Thus, discussed herein, the method provided can allow for a stabilization by improving the dissociation of LiPF₆, which suppresses the equilibrium decomposition to form PF₅.

The methods herein can help screen scavenger additives to eliminate PF₅, water, and hydrofluoric acid in the LiPF₆ electrolyte system. For example, Lewis Acids can enhance the dissociation of LiPF₆ by forming a complex with PF₆⁻. For example, in this case, PF₅ can be effectively scavenged by compounds containing phosphorous, oxygen, or nitrogen, which include lone pair electrons. For example, trimethyl phosphite. Conversely, water in LiPF₆ can be effectively scavenged by Lewis Base additives with a specific structure, including Ni—N, Si—O, phosphite, and isocyanate moieties. Hydrofluoric acid can be effectively scavenged by compounds with electron donating sites, such as amino silanes and phosphites.

Discussed herein, phosphorus pentoxide (P₂O₅) can be used as an additive to stabilize the electrolyte and electrodes in a lithium metal battery. Specifically, P₂O₅ is a dehydrating agent and acid scavenger. The hydrolysis product of P₂O₅ can help enhance dissociation of LiPF₆ to reduce or suppress PF₅ hydrolysis. Overall, a P₂O₅ additive can improve lithium metal deposition morphology for a denser deposition layer, in addition to alleviating transition metal dissolution and particle cracking problems.

### Definitions

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The term “solvent” as used herein refers to a liquid that can dissolve a solid, liquid, or gas. Non-limiting examples of solvents are silicones, organic compounds, water, alcohols, ionic liquids, and supercritical fluids.

The term “room temperature” as used herein refers to a temperature of about 15° C. to 28° C.

The term “coating” as used herein refers to a continuous or discontinuous layer of material on the coated surface, wherein the layer of material can penetrate the surface and can fill areas such as pores, wherein the layer of material can have any three-dimensional shape, including a flat or curved plane. In one example, a coating can be formed on one or more surfaces, any of which may be porous or nonporous, by immersion in a bath of coating material.

The term “surface” as used herein refers to a boundary or side of an object, wherein the boundary or side can have any perimeter shape and can have any three-dimensional shape, including flat, curved, or angular, wherein the boundary or side can be continuous or discontinuous. While the term surface generally refers to the outermost boundary of an object with no implied depth, when the term ‘pores’ is used in reference to a surface, it refers to both the surface opening and the depth to which the pores extend beneath the surface into the substrate.

### Lithium Metal Battery Cells with Phosphorus-Rich Solid Electrolyte Interphase

Various embodiments herein relate to lithium metal battery cells using an electrolyte that is enriched with an additive that prevents harmful effects in the battery cell, particularly on the lithium metal anode.

In an example, the battery cell can be a coin cell, a pouch cell, or other appropriate structure. The battery cell can be fully or partially enclosed in a housing, such as including a lid. The battery cell may be part of a stack of battery cells. The battery cell can be single use or rechargeable.

The lithium metal battery cell can include a cathode, an anode, and an electrolyte. Here, the electrolyte can further include an additive that aids in dissociation of the electrolyte solution and scavenging of certain chemicals within the battery cell. This can help reduce damage caused to the battery cell by degradation products.

In an example, the electrolyte additive can be phosphorous pentoxide (P₂O₅), which can help scavenge acid within the battery cell.

Lithium metal batteries are primary batteries that have metallic lithium as an anode. Here, the anode can be a lithium metal foil, such as a thin metal foil. In some cases, the lithium metal foil can have a thickness of 90 μm or less, of 50 μm or less, or of 20 μm or less. The anode can be, for example, a sandwiched configuration, with two lithium metal foils on opposing sides of a central foil, such as a copper foil. For example, the central foil, which may be copper, can have a thickness of 10 μm or less, or 9 μm or less, or 8 μm or less. In this case, the foils can be combined by mechanical means, such as by rolling.

In some cases, the anode can be made of Li—MnO₂, Li—(CF)ₓ, Li—FeS₂, Li—SOCl₂, Li—SOCl₂, BrCl, Li—BCX, Li—SO₂Cl₂, Li—SO₂, Li—I₂, Li—Ag₂CrO₄, Li—Ag₂V₄O₁₁, Li—SVO, Li—CSVO, Li—CuO, Li—Cu₄O(PO₄)₂, Li—CuS, Li—PbCuS, Li—FeS, Li—Bi₂Pb₂O₅, Li—Bi₂O₃, Li—V₂O₅, Li—CuCl₂, Li/Al—MnO₂, Li/Al—V₂O₅, Li—Se, Li-air, Li—FePO₄, or combinations thereof.

The cathode can be, for example, a high nickel cathode, such as an NMC (nickel manganese cobalt). NMC cathodes are mixed metal oxides of lithium, nickel, manganese, and cobalt. They have the general formula LiNiₓMn_{y}Co_{z}O₂. In many NMC samples, the composition can have has less than about 5% excess lithium. The cathode can, for example, have a composition with x+y+z that is near 1, with a small amount of lithium on the transition metal site.

In an example, the cathode can be made of LiNi_{0.6}Mn_{0.2}Co_{0.2}O₂ or LiNi_{0.8}Mn_{0.1}Co_{0.1}O₂. Such cathode materials can be prepared via slurry, such as by mixing the components. In an example, the cathode can include a slurry of NMC622, carbon black, and polyvinylidene fluoride in N-Methyl-2-pyrrolidone slurry.

The slurry can be coated, such as over a current collector, such as an aluminum current collector. Such a coating of the slurry can be thin, such as to create a 3 mAh cm⁻² cathode material with a thickness of less than 300 m to form a film. Both single sided and double-sided cathodes can be used.

In other examples, the cathode materials can include any of heat-treated manganese dioxide, carbon monofluoride, iron disulfide, thionyl chloride, thionyl chloride with bromine chloride, sulfur dioxide on Teflon®-bonded carbon, iodine that has been mixed and heated with poly-2-vinylpyridine (P2VP) to form a solid organic charge transfer complex, silver chromate, silver oxide and vanadium pentoxide, copper (II) oxide, copper oxyphosphate, copper sulfide, lead sulfide and copper sulfide, iron sulfide, lead bismuthate, bismuth trioxide, vanadium pentoxide, copper chloride, manganese dioxide, vanadium pentoxide, selenium, porous carbon, lithium iron phosphate, or combinations thereof.

The electrolyte can, for example, be lithium hexafluorophosphate (LiPF₆). The electrolyte can include, for example, 1M LiPF₆.

In some cases, the electrolyte can include lithium perchlorate, lithium tetrafluoroborate, lithium tetrachloroaluminate, lithium bromide, lithium iodide, lithium perchlorate, lithium hexafluorophosphate, lithium hexafluoroarsenate, lithium perchlorate, lithium salt, or combinations thereof. In some cases, the electrolyte can be in a solvent, such as propylene carbonate, dimethoxyethane, propylene carbonate, dimethoxyethane, gamma-butyrolactone, propylene carbonate, dioxolane, dimethoxyethane, thionyl chloride, sulfuryl chloride, sulfur dioxide, acetonitrile, dioxolane, or combinations thereof.

In some cases, the electrolyte can be LiPF₆ in organic carbonate solvents with brimstone additives. In some cases, the electrolyte can be brimstone composite polymer electrolytes.

Within the electrolyte solution, the additive can be mixed. For example, the P₂O₅ additive can be included at about 5 wt. % of the electrolyte, at about 4 wt. % of the electrolyte, or at about 3 wt. % of the electrolyte. In some cases, the P₂O₅ additive can be included at a range of about 2-10 wt. %, at about 3-9 wt. %, at about 4-8 wt. %, or at about 5-7 wt. % of the electrolyte solution.

Together, the electrolyte and the additive can form a phosphorous-rich solid electrolyte interphase. For example, the battery cell can include about 3 g Ah-1 electrolyte and additive.

The use of the electrolyte with the additive can have a number of advantages. For example, the electrolyte and the additive can form a protective coating on the lithium metal in situ in the battery cell, so as to protect the lithium metal anode in the battery cell. The electrolyte and the additive can induce uniform lithium deposition within the battery cell to help protect the anode without non-uniform pitting across the surface of the anode. Moreover, the electrolyte and the additive can induce a dense lithium deposition within the battery cell.

The use of the additive with the electrolyte can reduce parasitic reactions on the lithium metal anode and reduce transition metal leaching from the cathode. For example, the electrolyte with the additive can reduce formation of degradation produces such as hydrofluoric acid.

Where a polymeric electrolyte solution is used, the electrolyte and additive can induce layer-by-layer structure formation on the lithium metal anode. The layer-by-layer structure formation can include both layers of lithium metal anode protection layers and cathode-compatible polymeric lithium ion conducting layers. These can aid in extending the battery cell lifetime and efficacy. Moreover, such a layer-by-layer structure can provide mechanical support and robustness to the lithium metal anode. Such an embodiment can be nonflammable.

The battery cell can have a specific capacity of at least about 250 Wh/kg, at least about 300 Wh/kg, at least about 350 Wh/kg, at least about 400 Wh/kg, or at least about 450 Wh/kg. The battery cell can have an energy density of at least about 600 Wh/L, at least about 650 Wh/L, at least about 700 Wh/L, at least about 800 Wh/L, at least about 850 Wh/L, or at least about 900 Wh/L.

The lifetime of the battery cell with the additive in the electrolyte can have a good life expectancy. For example, the battery cell can run well for over 230 cycles, over 200 cycles, over 150 cycles, over 100 cycles, over 50 cycles, over 30 cycles, or over 20 cycles. Such cycling can occur with capacity retention of up to 90%, up to 85%, or up to 80%. In an example, the redox peaks for battery cell do not shift upon galvanostatic cycling. In an example, the intensity of organic SEI components in the cell during operation can be reduced. In an example, resistance of the cathode remains substantially steady during cycling.

In an example, the Rᵢₙₜ and the Rₑₜ of the battery cell remains substantially steady during cycling. For example, the Rᵢₙₜ of the battery cell can be about 40 to 50 ohms after 30 cycles, or at about 47 ohms after 30 cycles. For example, the R_{ct} of the battery cell can be about 90 to 100 ohms after 30 cycles. In an example, the ratio of DEC:EC can be about 0.37:1.0.

Moreover, the battery cell with the additive in the electrolyte can reduce degradation of the battery cell and the lithium metal anode. In an example, hydrofluoric acid is not a degradation product in the battery cell during operation. In an example, pitting on the lithium metal anode during operation is reduced. In an example, transition metal species such as Mn, Co and Ni are absent in the spectrum of the lithium metal anode after several cycles, such as bout 30 cycles. In an example, the lithium metal anode does not substantially crack during cycling.

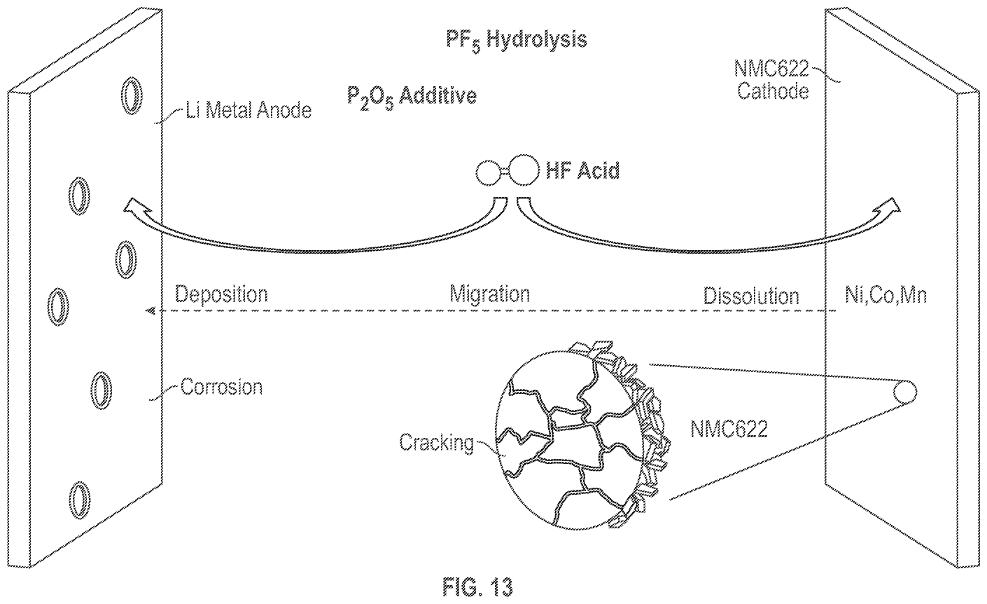

FIG. 13 depicts an illustrative view of a lithium metal battery cell. The battery cell can include a Li metal anode, an NMC622 cathode, and an electrolyte. Shown in the middle between the anode and the cathode is the hydrolysis of PF₅ that occurs when the P₂O₅ additive is not present. Here, hydrofluoric (HF) acid forms in the middle as NMC dissolves and migrates to deposit on the lithium metal anode. This dissolution can cause cracking on the cathode (shown in the insert) and corrosion on the lithium metal anode.

Overall, the hydrofluoric acid (HF) based side reaction in lithium hexafluorophosphate (LiPF6) electrolyte system hindered the direct application of LiPF₆ electrolyte (in organic carbonate solvents) for Li metal batteries. However, phosphorus pentoxide (P₂O₅) is an effective additive in LiPF₆ based electrolyte not only enable uniform and dense Li deposition but also mitigate the transition metal dissolution and cracking problems of NMC particles. The poor Li metal deposition behavior and the increasingly growth of cathode impendence can cause the poor cycle life of the Li∥NMC pouch cell in 1M LiPF6 electrolyte. In contrast, the cycle life of the pouch cell with P₂O₅ additive was greatly enhanced from 30 cycles to more than 230 cycles, with the capacity retention of 87.7%, as illustrated below in the Examples.

### EXAMPLES

Various examples of the present disclosure can be better understood by reference to the following Examples which are offered by way of illustration. The present disclosure is not limited to the Examples given herein.

### Example 1. Methodology

The Examples 2-5 below were prepared with the methods and materials as discussed with reference to Example 1 herein.

Materials. The electrolyte used was 1M LiPF₆ in the mixture of EC/DEC=50:50 (V/V), battery grade, purchased from Sigma-Aldrich. The P₂O₅ was ≥99.99%, trace metal basis, from Sigma-Aldrich. The P₂O₅ was dried under vacuum at 80° C. inside argon-filled glovebox for 24 hours prior to use. The single crystal LiNi0.6Mn0.2Co0.2O2 (NMC622) was purchased from Targray Technology International Inc.

Electrolyte. 1M LiPF₆ electrolyte (H₂O<10 ppm, tested by Karl Fischer Titrator) from Sigma-Aldrich was used without further purification. 1M LiPF₆ with P₂O₅ additive was made by adding 5 wt. % P₂O₅ powder in 1M LiPF₆ electrolyte. The dispersion was first stirred for 24 hours at room temperature then centrifuged for 2 hours. The supernatant was used as a IM LiPF₆+P₂O₅ electrolyte.

Electrodes. Electrodes were prepared for coin-cells and pouch cells. A lab-made thin Li foil (50 μm in thickness) was prepared. A double-side Li metal anode was prepared by sandwiching a copper foil (9 μm, MTI Corporation) with two pieces of lab-made Li metal foil (50 μm in thickness) and pressed with a mechanical roller.

The cathode slurry was prepared by mixing 90 wt. % NMC622, 5 wt. % carbon black (Supper C65), and 5 wt. % polyvinylidene fluoride (PVDF, Sigma-Aldrich, Mw-534,000) in N-Methyl-2-pyrrolidone (NMP, Anhydrous, 99.5%, Sigma-Aldrich) through a centrifugal mixer (Thinky, AR-100) for 15 mins. All the materials in the slurry preparation except NMP were dried under vacuum at 70° C. for 24 hours prior to use. NMP was dried with the 3 Å molecular sieves prior to use. The weight ratio of liquid to solid in the slurry was 1.65. The slurry was coated with an automatic tape casting coater (MTI corporation) onto an aluminum current collector (16 μm, Gelon LIB Group) with the film applicator set to 300 m to make 3 mAh cm-2 NMC622 cathode.

The coated electrodes were transferred into the glovebox and dried at room temperature for 12 hours. Then the electrodes were dried under vacuum inside glovebox at 120° C. for 12 hours prior to use. The thickness of electrodes (90 μm for single side) was controlled by calendaring process through mechanic roller. Single-sided and double-sided cathodes were prepared for coin cells and pouch cells, respectively.

Cell assembly and electrochemical experiments. CR-2016 type coin cells (Gelon LIB Group) were used in measurements of the Li∥Li symmetric cell cycle stability. Celgard-2400 was used as the separator.

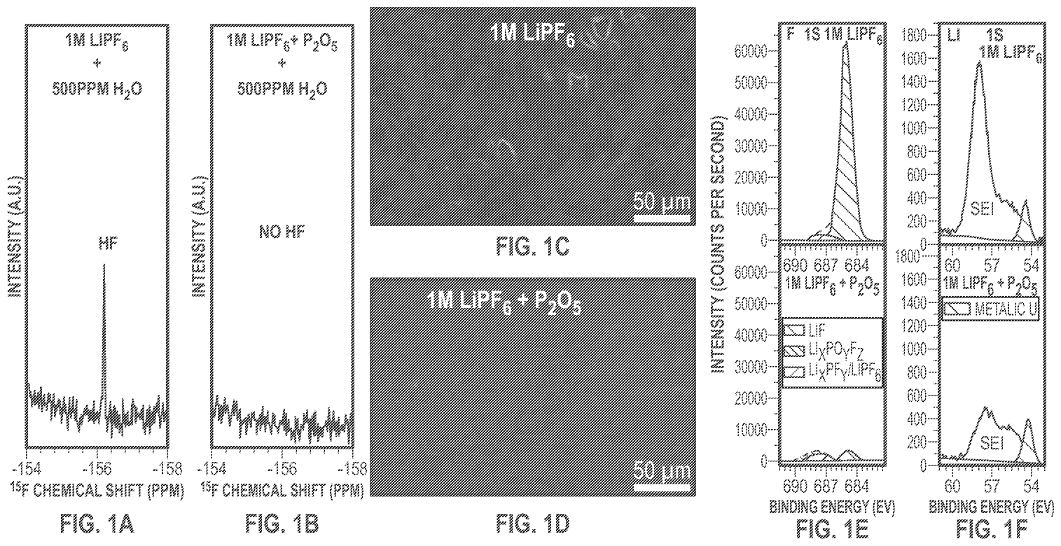

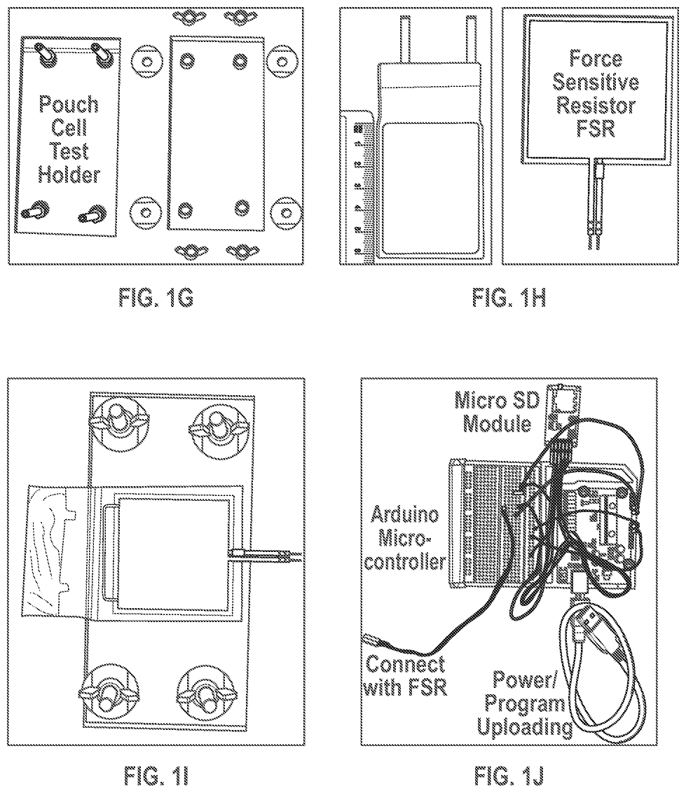

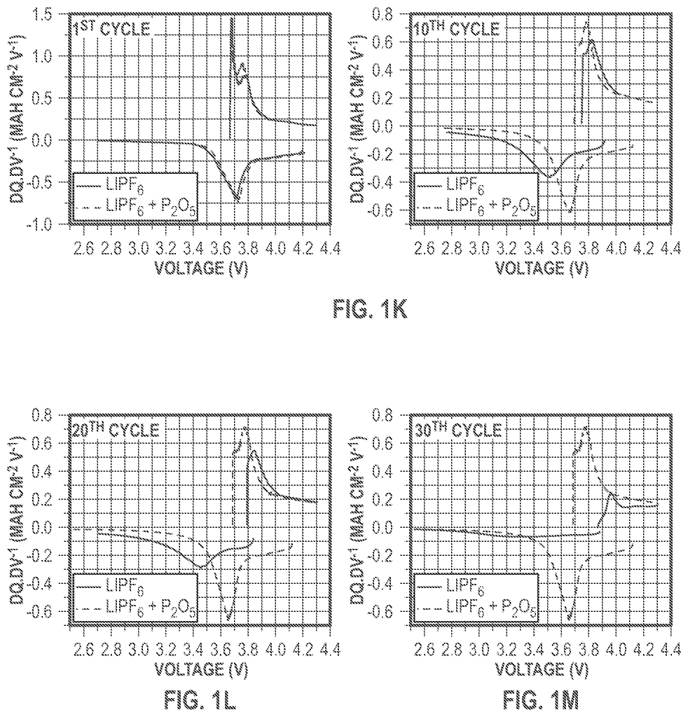

Pouch cells were assembled inside an argon-filled glovebox. The amount of electrolyte in the pouch cells was 3 g Ah-1. A lab-made pouch cell test holder (shown in FIGS. 1G-1J) was used during cycling. FIGS. 1G-1J depict photographs of a pouch cell testing holder (FIG. 1G), a force sensitive resistor (FIG. 1H), an assembled testing holder (FIG. 1I), and a pressure loading calibration by an Arduino microcontroller (FIG. 1J).

Example battery cells are summarized below in Table 1:

TABLE 1
Example Battery Cells

| | | | | Specific | Energy |
|---|---|---|---|---|---|
| Battery | Anode | Cathode | Electrolyte | Capacity | Density |
| Lithium | Thin | LiNi_{0.6}Mn_{0.2}Co_{0.2}O₂ | LiPF₆ in | 350 Wh/kg | 800 Wh/L |
| Metal 1 | 20 um | (NMC622) | organic | | |
| | lithium | | carbonate | | |
| | metal | | solvents | | |
| | foil | | with P₂O₅ | | |
| | | | additives | | |
| Lithium | Thin | High nickel | P₂O₅ | 450 Wh/kg | 850 Wh/L |
| Metal 2 | 20 um | cathode | composite | | |
| | lithium | LiNi_{0.8}Mn_{0.1}Co_{0.1}O₂ | polymer | | |
| | metal | (NMC811) | electrolytes | | |
| | foil | | | | |
| Lithium-ion | Graphite | LiNi_{0.6}Mn_{0.2}Co_{0.2}O₂ | LiPF₆ in | 270 Wh/kg | 650 Wh/L |
| Control | | (NMC622) | organic | | |
| | | | carbonate | | |
| | | | solvents | | |

The cycling experiments were performed with Neware battery testers. The Li∥NMC622 cells were tested under galvonastatic charging to 4.3 V and then held the voltage at 4.3 V until the current dropped less than C/30. After that, the cells were galvanostatically discharged until the voltage was less than 2.5 V. The C rate for formation cycles were kept C/20 for charging and discharging. After formation cycles, C/10 was used for charging and C/3 was used for discharging. Constant voltage was held until the current was less than C/30.

Coulombic Efficiency Measurements. Average coulombic efficiency (CE) measurements were calculated for the battery cells. CR-2016 type coin cells were used to measure the average coulombic efficiency. A lab-made Li foil with the thickness around 50 μm was first weighed and then pressed to a Cu substrate as the working electrode. Another identically made lithium electrode was used as the counter electrode.

Galvanostatic stripping was applied to the working electrode, followed by deposition with the same current and same period of time to complete one cycle. After a set number of cycles, any remaining lithium on the working electrode was completely stripped using a 0.5 mA cm-2 current until the stripping cutoff potential (1 V) was reached.

The average CE data was obtained by the average of four individual battery cells for each data point. Representative voltage and current profiles in the measurement of average CE is shown in FIGS. 1K to 1M. The average CE can be calculated from the following equation:

$$C {E}_{Average} = \frac{( {T}_{s} \times J + n \times {C}_{C} ) \times A}{{m}_{L i} \times Q + n \times {C}_{C} \times A}$$

where n is the cycle number; Cc is the cycling capacity (e.g., 2 mAh cm-2 with 1 mA cm⁻² cycling for 1 h); Ts (hour) is the time to complete the stripping of the working electrolyte; J is the current to complete stripping (0.5 mA cm⁻²), A is the area of the working electrode (1.266 cm⁻²), and mLi is the original mass (in mg) of the Li on the working electrode. Q is the theoretical capacity of Li (3.86 mAh mg⁻¹).

Electrochemical Impedance Spectroscopy. Additionally, Li∥Li, NMC622∥NMC622 symmetric cells were used in Electrochemical Impedance Spectroscopy (EIS) testing. The Li∥NMC622 coin cells were tested after cycles. For each specific cycle, two cells were tested. After cycling, two cells were disassembled and the same electrodes were reassembled to make Li∥Li, NMC622∥NMC622 symmetric cells with another separator and refilled electrolyte.

The EIS measurements were conducted using the Gamry potentiostat Interface 1000, scanning over the frequency range from 106 Hz to 0.01 Hz with 2 mV amplitude. The EIS data was analyzed by ZSim software to deconvolute the circuit elements using equivalent circuit model.

Scanning Electron Microscope imaging. The surface morphology and the thickness of the electrode were characterized using scanning electron microscope (SEM, Nova Nano 5450, 10 kV). The samples were retrieved in an argon-filled glovebox and washed with dimethyl carbonate thoroughly to remove the residual electrolyte. Prior to the SEM characterization, the samples were dried at room temperature for 24 hours inside the argon-filled glovebox. The samples were then transported to the SEM facility inside a stainless-steel tube with KF-flange sealing. The samples were loaded in the SEM using a glove-bag with argon purging gas without exposing to ambient environment. The elemental mapping of the samples was collected using an Energy Dispersive X-ray (EDX) spectrometer coupled with the SEM. The focused ion beam (Quanta™ 3D 200i with Ga liquid metal ion source) was used to precisely prepare the cross-sectional image of the NMC622 cathode particles. The ion gun voltage was set to 30 kV, and the current was 30 nA and 7 nA for bulk milling and polishing current, respectively.

X-ray photoelectron spectroscopy. XPS data was collected using Kratos AXIS Supra (Al Kα=1486.7 eV) at UC Irvine Materials Research Institute (IMRI). The samples were prepared following the same procedure for SEM samples. The samples were transported to the XPS facility inside a stainless-steel tube with KF flange sealing filled with argon. Finally, the samples were loaded in the sample chamber in the glovebox integrated with Kratos AXIS Supra for XPS analysis. All peaks of XPS data were analyzed by Casa XPS41 and calibrated with the reference peak of C 1 s at 284.6. Relative sensitivity factors for the Kratos AXIS Supra are listed below in Table 2:

TABLE 2
Sensitivity factors for XPS.

| C | O | F | S | N | Li |
|---|---|---|---|---|---|
| 1s | 1s | 1s | 2p | 1s | 1s |
| 0.278 | 0.736 | 1 | 0.723 | 0.477 | 0.025 |

The relative atomic ratio was calculated by the following equation:

$$R {A}_{i} = \frac{{A}_{i} / {S}_{i}}{\sum {A}_{i} / {S}_{i}} \times 100 \%$$

Where RAi is the relative atomic ratio of component I, Ai is Area of the deconvoluted peak of component I, and Si is the relative sensitivity factor for component i.

The battery cells were additionally analyzed with NMR spectroscopy and Online Electrochemical Mass spectrometry (OEMS). For NMR, a ¹⁹F NMR spectra was used.

### Example 2. Stabilization of Li Metal Anode and Electrolyte Interphase by P₂O₅ Additive

FIGS. 1A-1B depict ¹⁹F NMR spectra of the electrolyte. In FIG. 1A, no P₂O₅ additive is used. In FIG. 1B, P₂O₅ additive is used in the electrolyte. FIGS. 1C-1D show corresponding SEM images of Li metal electrode after soaking in 1M LiPF₆ electrolyte. FIG. 1C shows Li metal electrode after soaking in 1M LiPF₆ electrolyte without the P₂O₅ additive, while FIG. 1D shows Li metal electrode after soaking in 1M LiPF₆ electrolyte with the P₂O₅ additive for 2 days' time. FIGS. 1E and 1F depict the corresponding F is XPS spectra (FIG. 1E) and Li is XPS spectra (FIG. 1F).

The effectiveness of HF elimination in the samples can be observed by ¹⁹F NMR spectra, as shown in FIGS. 1A to 1B. Here, the HF peak (−156.5 ppm) is missing by the application of P₂O₅ in 1M LiPF₆ (in FIG. 1).

Thus, the Li metal corrosion problem has been mitigated, which can be seen in FIG. 1D. The clear corrosion pits on Li metal anode after soaking in 1M LiPF₆ electrolyte for 2 days is observed in the FIG. 1C, while with the help of P₂O₅ additive, the Li metal surface remains almost the same.

The corresponding F is XPS spectra (in FIG. 1E) indicates a large amount of LiF (684.5 eV) is formed on Li metal anode when corrosion happened in the 1M LiPF₆ electrolyte.

In addition, the thickness of the SEI is alleviated as the ratio of SEI peak and metallic Li peak (54.8 eV) (in FIG. 1F) is decreased when applying the P₂O₅ additive. Consequently, the more stable Li metal anode surface against the electrolyte lead to smaller resistance of the Li metal anode, while the increasingly growth resistance indicates the continuously corrosion reaction happened on Li metal anode with 1M LiPF₆ electrolyte.

FIGS. 1K to 1N depict differential capacity (dQ/dV vs. voltage) plots comparing the commercial (“LiPF₆”) and P₂O₅-modified (“LiPF₆+P₂O₅”) LiPF₆ electrolytes. FIG. 1K depicts the differential capacity after one cycle, FIG. 1L depicts the differential capacity after ten cycles, FIG. 1M depicts the differential capacity after 20 cycles, and FIG. 1N depicts the differential capacity after 30 cycles. Here, The major redox peaks for the cell using the commercial electrolyte shift to higher voltages during charge (from 3.76 V in the 1^{st} cycle to 3.96 V in the 30th cycle) and lower voltages during discharge (from 3.71 V in the 1^{st} cycle to 3.27 V in the 30th cycle). However, the redox peaks for the cell using the P₂O₅-modified electrolyte do not shift upon galvanostatic cycling.

### Example 3. Uniform Li Deposition Layer Enabled by P₂O₅ Additive

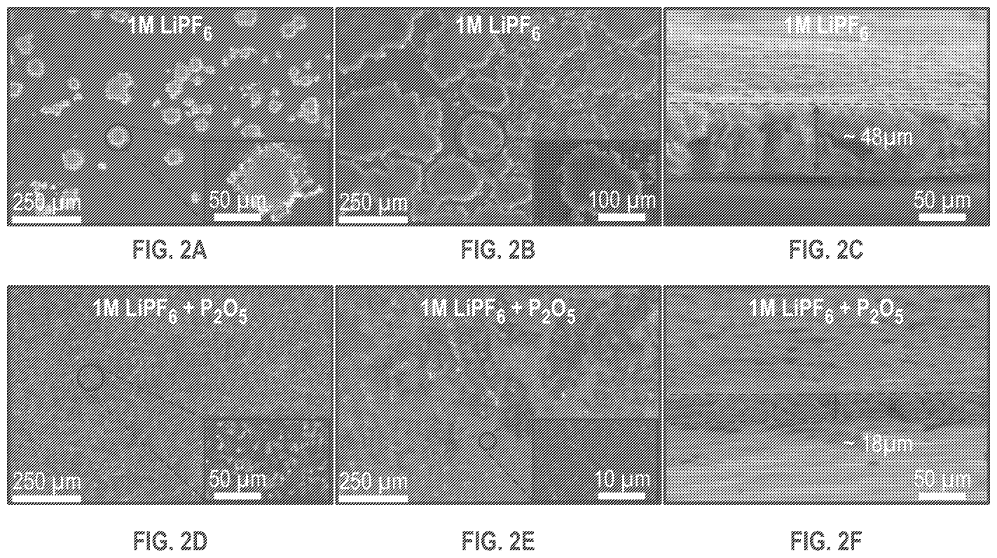

A salient difference between 1M LiPF₆ electrolyte with and without additive can be anticipated in the morphology of the Li deposits. By comparing the nucleation stage of Li metal deposits in FIGS. 2A to 2F, the Li nucleation density in 1M LiPF₆ with P₂O₅ additive is greatly improved in addition with the more uniform size distribution.

Specifically, FIGS. 2A, 2B, 2D, and 2E depict top view SEM images of lithium deposited on lithium metal galvanostatically at 0.3 mA cm⁻². FIGS. 2A and 2D depict this after 1 hour, while FIGS. 2B and 2E depict this after 10 hours. FIGS. 2A to 2B show samples without the P₂O₅ additive. FIGS. 2D to 2E show samples with the P₂O₅ additive. FIGS. 2C and 2F depict cross-sectional SEM images of lithium deposited on lithium metal galvanostatically at 0.3 mA cm⁻² for ten hours in 1 M LiPF₆ electrolyte. FIG. 2C depicts a sample without the P₂O₅ additive, while FIG. 2F depicts a sample with the P₂O₅ additive.

Although 1M LiPF₆ electrolyte can generate much higher intensity of LiF on Li metal surface (see FIG. 1E), the exposed pitting area would favor the Li nucleation and deposition process thus lower the nucleation density and cause the porous Li deposition layer.

In the long-term deposition process, the Li deposition layer (see FIG. 2B) in 1M LiPF₆ electrolyte is discrete because of the low nucleation density, while the Li deposition layer (see FIG. 2E) is much more homogeneous and denser when applying the P₂O₅ additive. The thickness of 3 mAh cm⁻² (theoretical thickness: 15 μm) Li deposition layer is reduced from about 48 m (see FIG. 2C) to about 18 m (see FIG. 2F) with the help of the P₂O₅ additive.

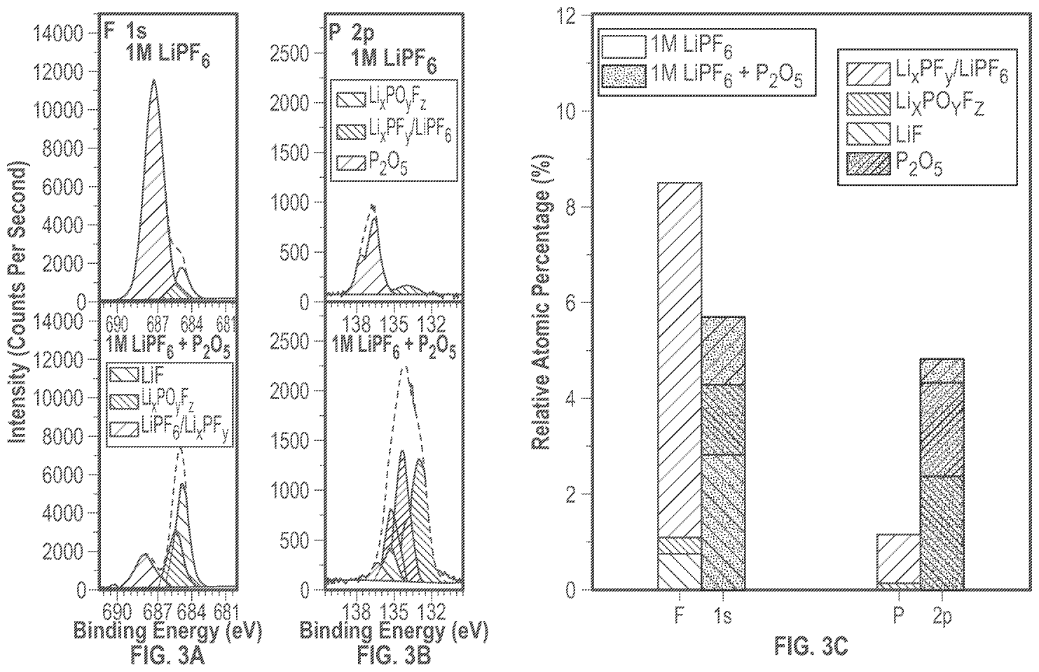

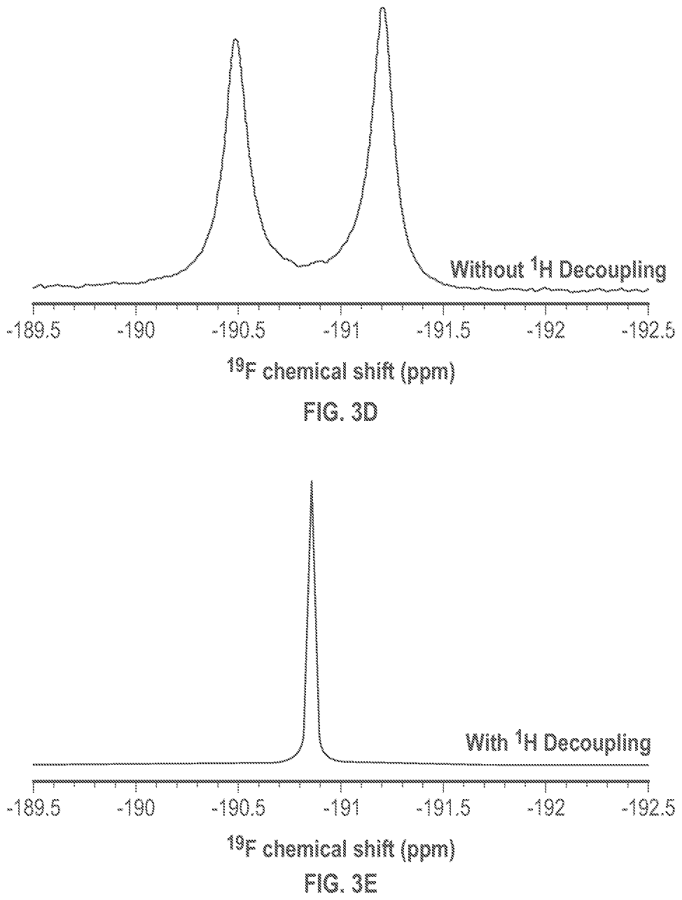

The SEI properties also played an important role for the uniform and dense deposition layer. FIG. 3A depicts an F is XPS spectra, while FIG. 3B depicts a P 2p XPS spectra. FIG. 3C depicts the relative atomic percentage of F and P on Li metal foil after galvanostatically (0.3 mA cm⁻²) for 10 hours in 1 M LiPF₆ without the P₂O₅ additive.

FIGS. 3D and 3E depict ¹⁹F single-pulse NMR measurements in the HF region. FIG. 3D depicts a spectrum without ¹H-¹⁹F heteronuclear decoupling, while FIG. 3E depicts a spectrum with ¹H-¹⁹F heteronuclear decoupling. FIGS. 3D and 3E were performed on a 1 M LiPF₆ without the P₂O₅ additive.

Shown in FIG. 3A is a much higher intensity of LiF (684.5 eV), and LixPOyFz (685.5 eV). A lesser intensity of organic SEI components (see FIGS. 3D and 3E) was generated during Li deposition in 1M LiPF₆ electrolyte with the P₂O₅ additive. These indicate the 1M LiPF₆ electrolyte with P₂O₅ will electrochemically generate more stable ceramic SEI than the electrolyte without additive. The higher SEI repair rate was beneficial for smooth Li deposition.

### Example 4. Superior Electrochemical Performance and the Working Mechanism of P₂O₅ Additive

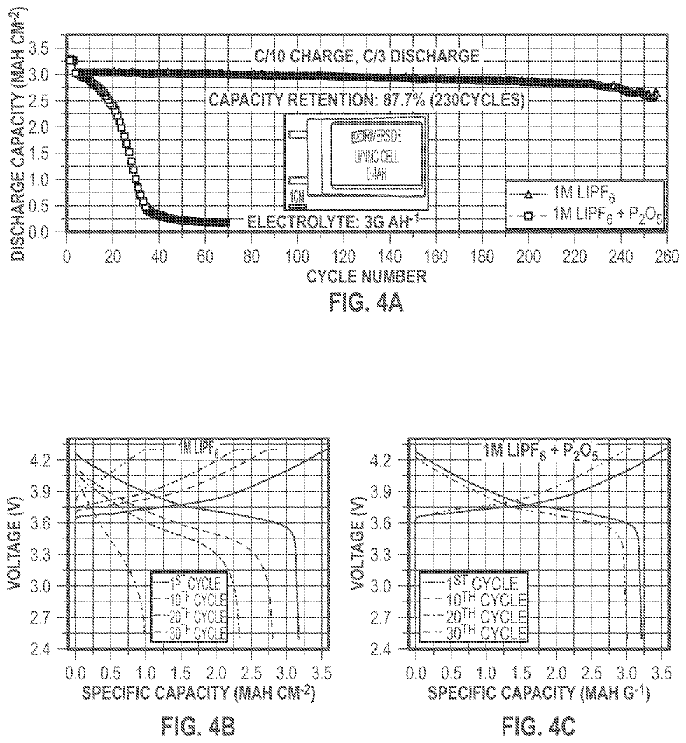

FIG. 4A depicts cycling performance of 0.4 Ah Li∥NMC622 pouch cell (50 μm Li anode and 3 mAh cm⁻² cathode areal capacity) in lean electrolyte (electrolyte to capacity ratio=3 g Ah⁻¹) at C/10 charging and C/3 discharging. Optical image of the 0.4 Ah Li∥NMC622 pouch cell was inserted. FIGS. 4B and 4C depict cell voltage profiles for 0.4 Ah Li∥NMC622 pouch cell in 1M LiPF6 electrolyte. FIG. 4B shows this without the additive, while FIG. 4C shows this with the P₂O₅ additive.

With the help of the P₂O₅ additive, the cycle life of 0.4 Ah Li∥NMC622 pouch cell has was improved (see FIG. 4A) from 30 cycles to more than 200 cycles with capacity retention of 87.7% (230 cycles). The increasingly growth of the cell polarization from 1st cycle to 30th cycle is observed in the voltage profile of 1M LiPF₆ electrolyte in FIG. 4B, while the voltage profile almost remained the same for 1M LiPF₆ electrolyte with P₂O₅ additive in FIG. 4C.

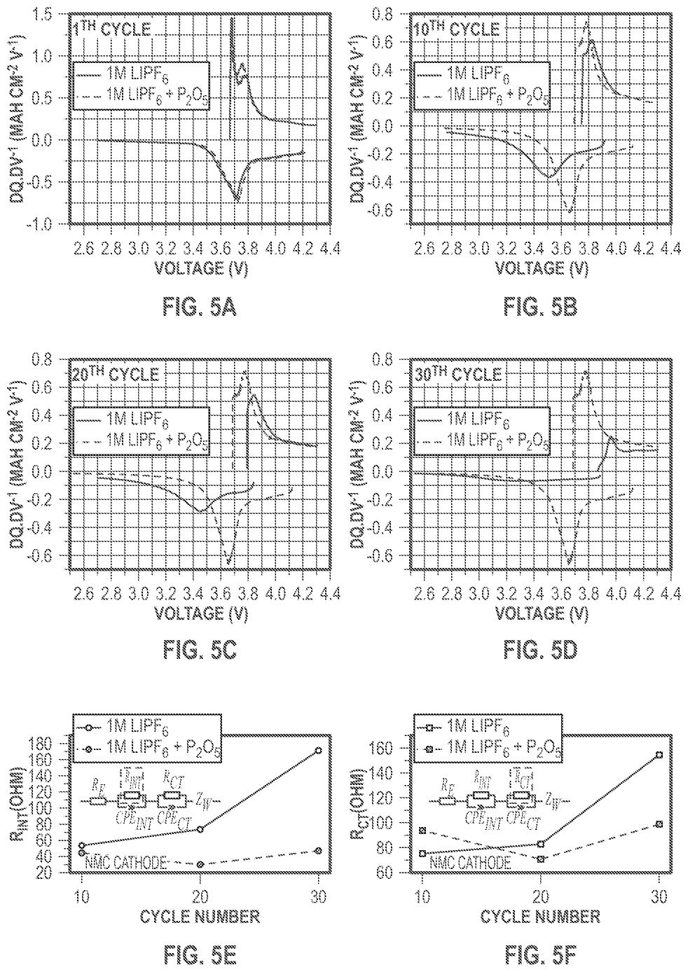

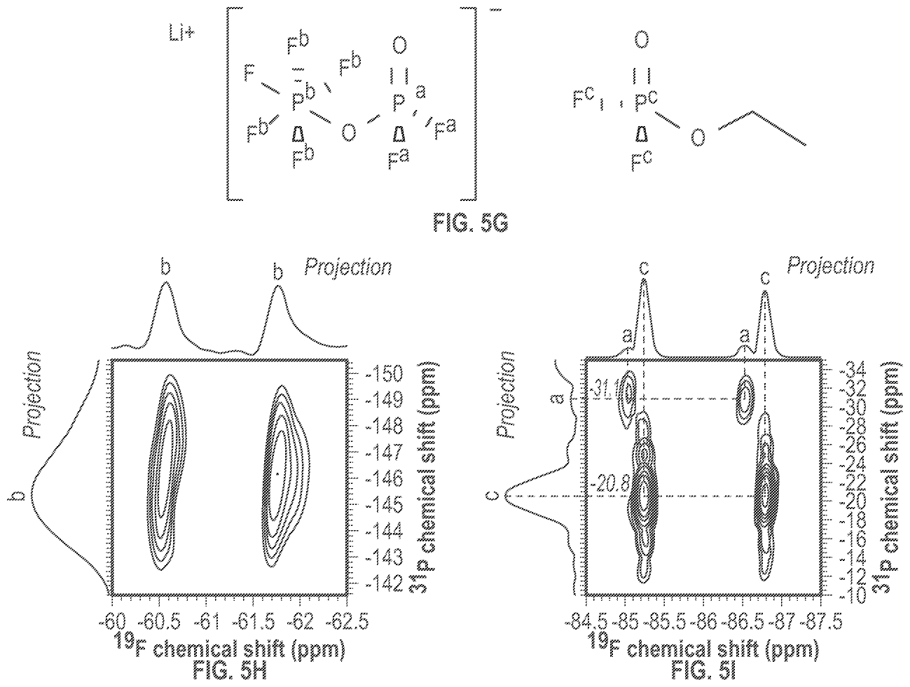

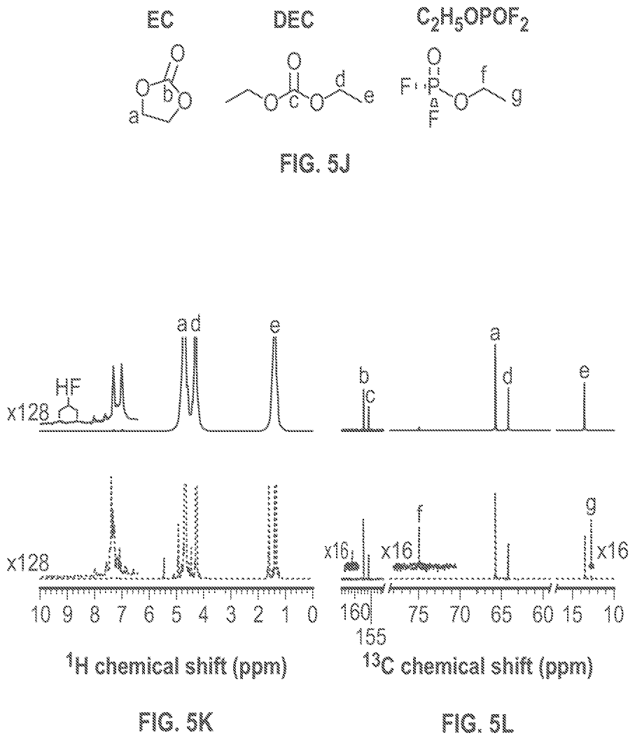

FIGS. 5A to 5D depict dQ/dV vs. voltage plot of the comparison between 1M LiPF₆ electrolyte without and with P₂O₅ additive. FIG. 5A depicts this after the 1^{st} cycle, FIG. 5B after the 10^{th} cycle, FIG. 5C after the 20^{th} cycle, and FIG. 5D after the 30^{th} cycle.

The corresponding dQ/dV vs. voltage profile (in FIGS. 5A to 5D) was plotted in order to compare the polarization of the cell. The peak voltage shift of dQ/dV plot can be regarded as the change of the cell overall polarization. From FIGS. 5A to 5D, the major redox peak for the cell testing in 1M LiPF₆ electrolyte shifted to higher voltages (from 3.76 V—1st cycle to 3.96 V—30th cycle) for charging process and shifted to lower voltages (from 3.71 V—1st cycle to 3.27 V—30th cycle) for discharging process, which indicated the higher degree of polarization of the cell. The overall polarization of the cell contributed to ohmic, charge transfer and diffusion related effects.

In order to deconvolute the origin of the polarization, the EIS analysis on NMC622 cathode and Li metal anode was conducted by using symmetric cells after the cells testing. After cycling, two cells in the same condition were disassembled, and the electrodes with same polarity were paired with new separator and electrolyte to reassemble the NMC622∥NMC622 symmetric cells and Li∥Li symmetric cells for the testing of EIS on NMC622 cathode and Li metal anode, respectively.

FIG. 5E and FIG. 5F depict deconvoluted EIS analysis. FIG. 5E depicts interfacial resistance, while FIG. 5F depicts charge transfer resistance versus cycle number in different electrolyte.

The equivalent circuit used to fit the EIS data, which is shown in the insert of FIGS. 5E and 5F, included six circuit elements as follows. The ohmic resistance of the system, RE, was the intercept at high frequency. The first semi-circle consists of interfacial resistance, Rᵢₙₜ, and its corresponding capacitance, CPEint. The second semi-circle was attributed to the charge transfer resistance, Rct, and its corresponding capacitance, CPEct. The low frequency region included the Warburg impedance, Zw. From the deconvoluted EIS data, both Rᵢₙₜ and R_{ct} increasingly grew with cycle number for 1M LiPF₆ electrolyte, while those values slightly change for 1M LiPF₆ with P₂O₅ additive. The Rᵢₙₜ for 1M LiPF₆ increased to 171.7Ω at 30th cycle, while that for 1M LiPF₆ with P₂O₅ additive was 47.11Ω. The Rₜ for 1M LiPF₆ increased to 154.6Ω at 30th cycle, while that for 1M LiPF₆ with P₂O₅ additive was 98.84Ω.

The resistance of Li metal anode continuously decreased with cycle number no matter in which electrolyte. And the resistance difference was far less than that on cathode side, which indicated the major polarization of the cell was coming from the NMC622 cathode.

FIGS. 5G to 5I depict liquid-state 2D ¹⁹F{³¹P} HMQC through-bond correlation NMR measurements on the P₂O₅-modified LiPF₆ electrolyte. This established interactions between the ¹⁹F doublet at −61.1 ppm and ³¹P signal at approximately −146 ppm, shown in FIG. 5H, as well as the ¹⁹F doublet centered at −85.7 ppm and ³¹P signal at −31.1 ppm, shown in FIG. 5I. These ¹⁹F-³¹P through-bond correlation experiments confirm the existence of the OPF₂OPF₅ anions. Additionally, the region in FIG. 5I showed the ¹⁹F-³¹P through-bond correlation between the ¹⁹F signal centered at −86.0 ppm and ³¹P signal at −20.8 ppm, associated with C₂H5OPOF₂. Chemical structures of these electrolyte species are labeled with ¹⁹F and ³¹P signal assignments in FIG. 5G.

FIGS. 5J to 5L depict liquid-state single-pulse NMR measurements of the commercial and P₂O₅ modified 1 M LiPF₆ electrolyte in ED/DEC (50/50 v/v) cells. FIG. 5J depicts the corresponding structures. FIG. 5H depicts the ¹H NMR spectra, while FIG. 5I depicts the ¹³C NMR spectra. Integration of the relative ¹³C signal intensities revealed that the molar ratio of DEC:EC is 0.57:1.0 and 0.37:1.0 in the commercial and P₂O₅-modified electrolyte, respectively, establishing that DEC is the major source for organic species in the reaction products generated from P₂O₅. Chemical structures of major proton- and carbon-containing electrolyte species are labeled with 1H and 13C signal assignments in FIG. 5J.

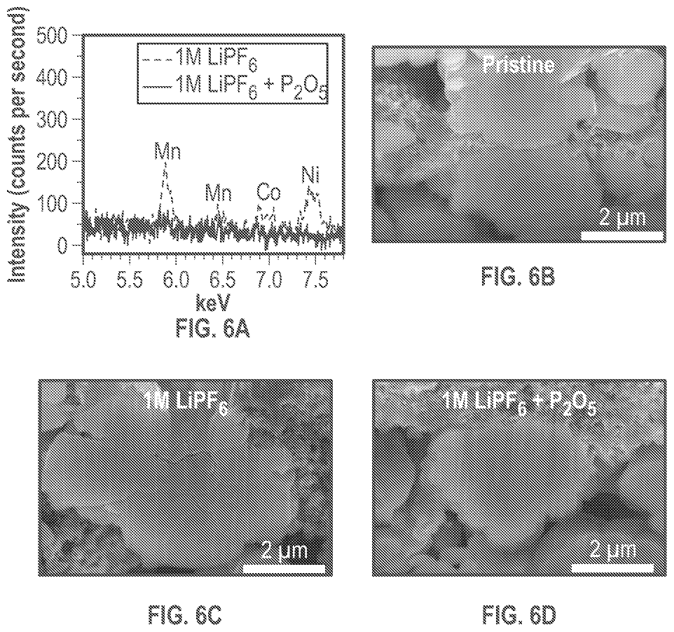

FIG. 6A depicts EDS spectra of Li metal anode and FIB-SEM images of FIG. 6B pristine NMC622 particles, and the NMC622 material after 30 cycles under C/10 charge and C/3 discharge in 1M LiPF₆ electrolyte FIG. 6C without and FIG. 6D with P₂O₅ additive.

The P₂O₅ additive not only improved the Li deposition process, but also stabilized the NMC622 cathode during cycling. The transition metal dissolution is a major problem for 1M LiPF₆ electrolyte system because of the corrosive HF can dissolve TM²⁺ (TM=Co, Ni, Mn) and the EDS analysis result (see FIG. 6A) shown the distinct evidence.

After 30 cycles in 1M LiPF₆ electrolyte, the Li metal anode had a significant content of transition metal including: Mn, Co and Ni. In contrast, transition metal dissolution problem was suppressed in the presence of the P₂O₅ additive, as presented by the absence of Mn, Co and Ni signal in the EDS spectrum of Li metal anode after 30 cycles in 1M LiPF₆ electrolyte with the P₂O₅ additive.

The cracking problem for high Ni content cathode material was the dominant reason for the capacity fading, shown in FIGS. 6C and 6D. These demonstrate the FIB-SEM images of NMC622 particles before and after 30 cycles in 1M LiPF₆ electrolyte without and with P₂O₅ additive. The distinct cracks (see FIG. 6C) were observed on NMC622 particles after 30 cycles in 1M LiPF₆, while the NMC622 particles remained the same after 30 cycles in 1M LiPF₆ with P₂O₅ additive in FIG. 6D. The cracking issue could be the reason for the increasingly growth of cathode resistance, due to the precipitation of TMF₂ (TM=Co, Ni and Mn) on the exposed cracking surface

### Example 5. Additional Lithium Metal Cell Testing

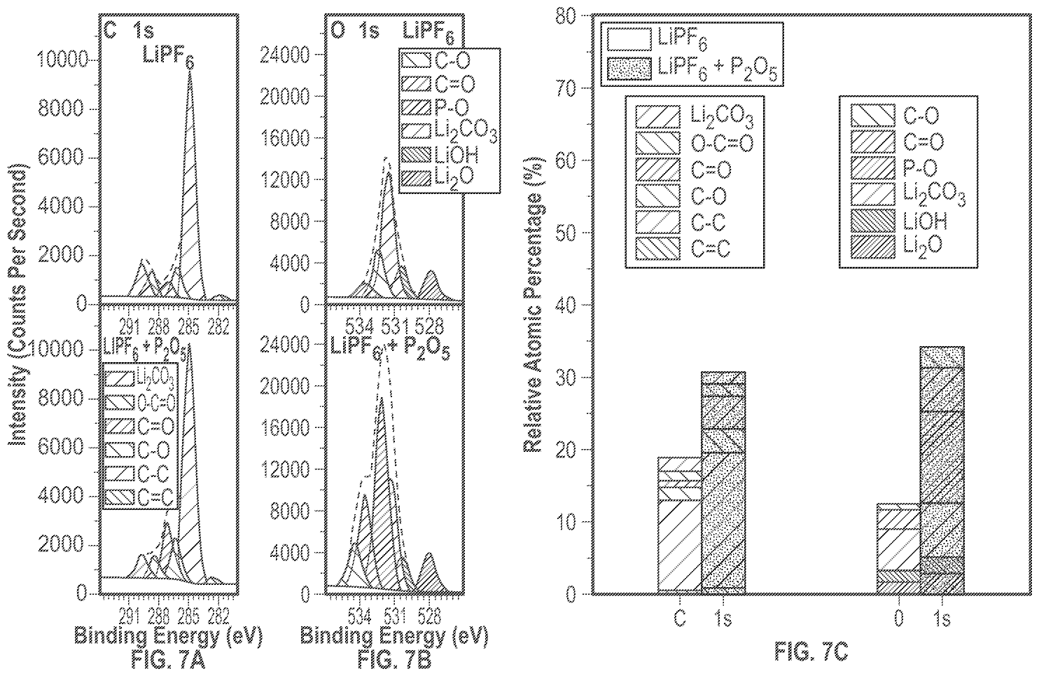

FIGS. 7A to 7C depict XPS spectra of the lithium metal surface after immersion in the commercial (top) or P₂O₅ modified (bottom) LiPF₆ electrolyte for 48 hours. FIG. 7A depicts the C 1 s XPS spectra, while FIG. 7B depicts the O 1 s XPS spectra. FIG. 7C depicts the relative atomic percentage of C and O atoms on the surfaces.

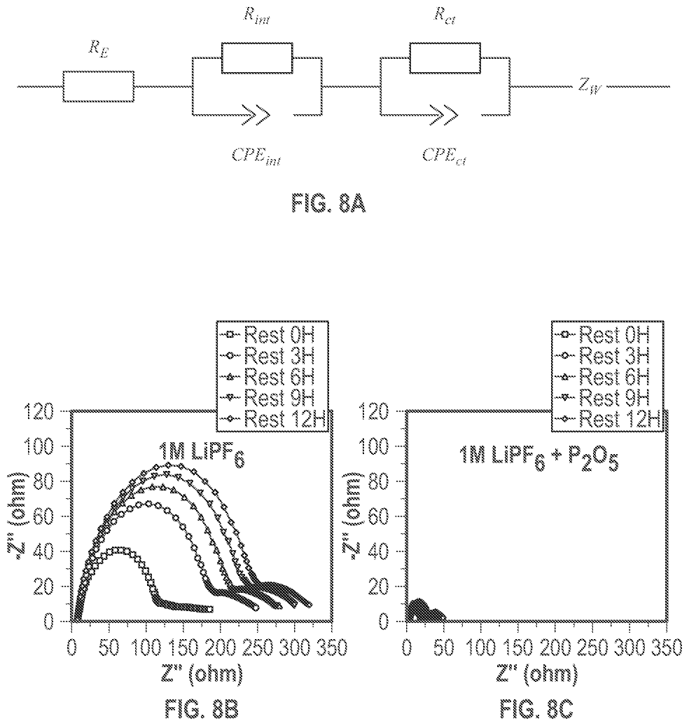

FIGS. 8A to 8C depict EIS Nyquist plots performed at different rest times in Li∥Li symmetric cells. The EIS data was analyzed by ZSim software to deconvolute the circuit elements using the equivalent circuit model displayed in FIG. 8A. FIG. 8B depicts the commercial LiPF₆ electrolyte, while FIG. 8C depicts the P₂O₅ modified LiPF₆ electrolyte.

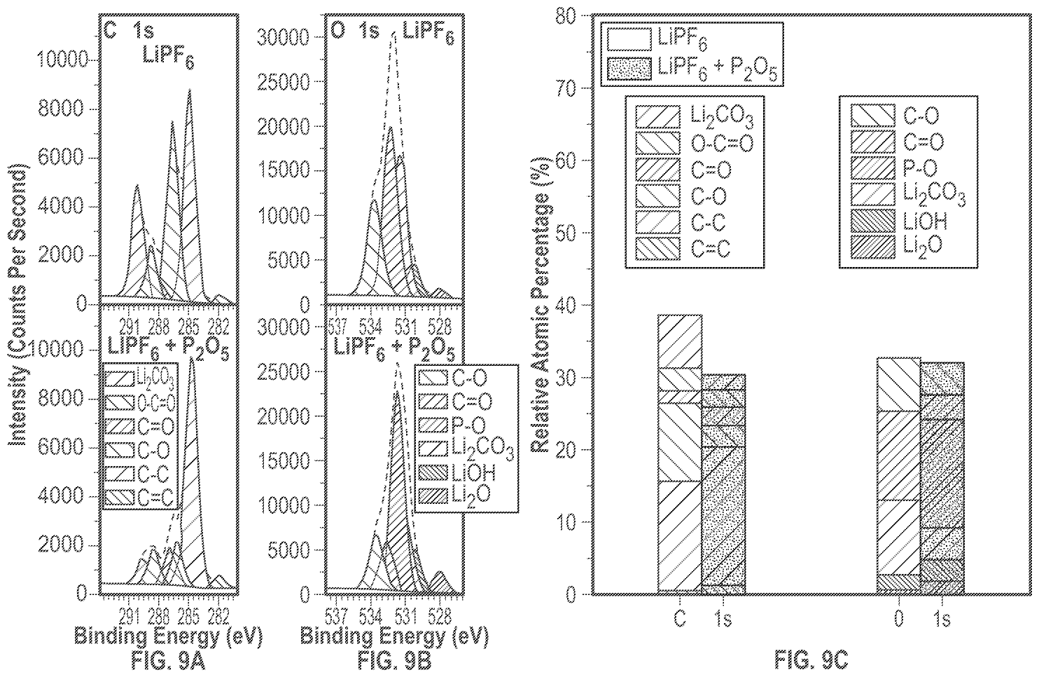

FIGS. 9A to 9B depict further C 1 s and O 1 s XPS spectra of the Li metal surface after galvanostatic deposition (0.3 mA cm-2) for 10 hours in commercial (top) or P₂O₅-modified (bottom) 1 M LiPF₆ electrolyte. FIG. 9C depicts relative atomic percentage of C and 0 atoms on the surfaces.

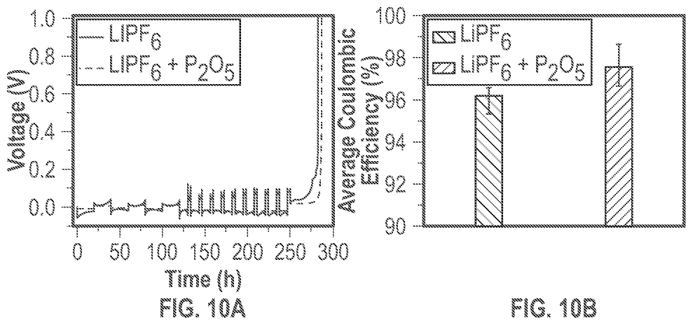

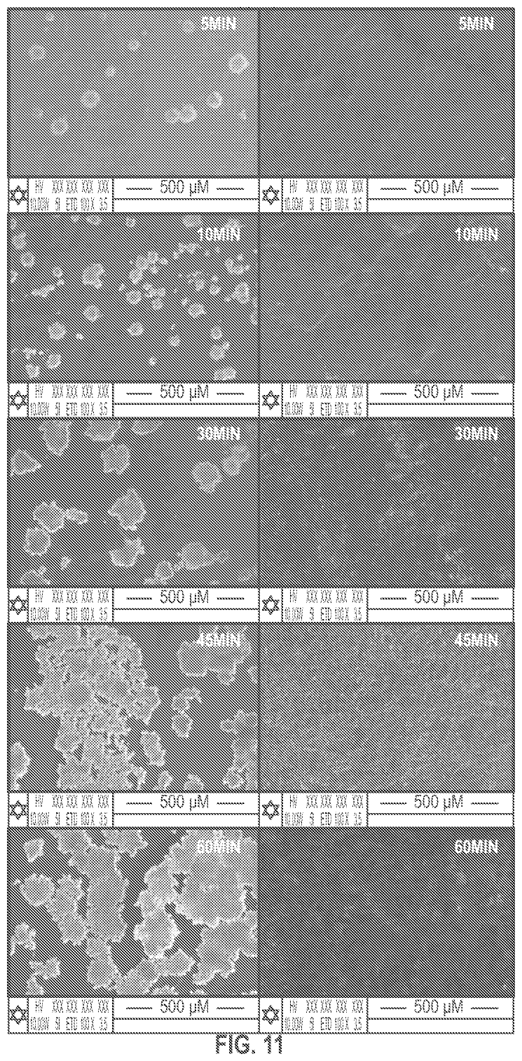

FIG. 10A shows the representative Li deposition and stripping curves to measure the CE, while FIG. 10B depicts the average CE of Li deposition-stripping measured from the pristine and P₂O₅-modified LiPF₆ electrolyte.

FIG. 11 depicts SEM images. The left column depicts Li deposition from the pristine LiPF₆ electrolyte. The right column depicts Li deposition from the P₂O₅-modified LiPF₆ electrolyte.

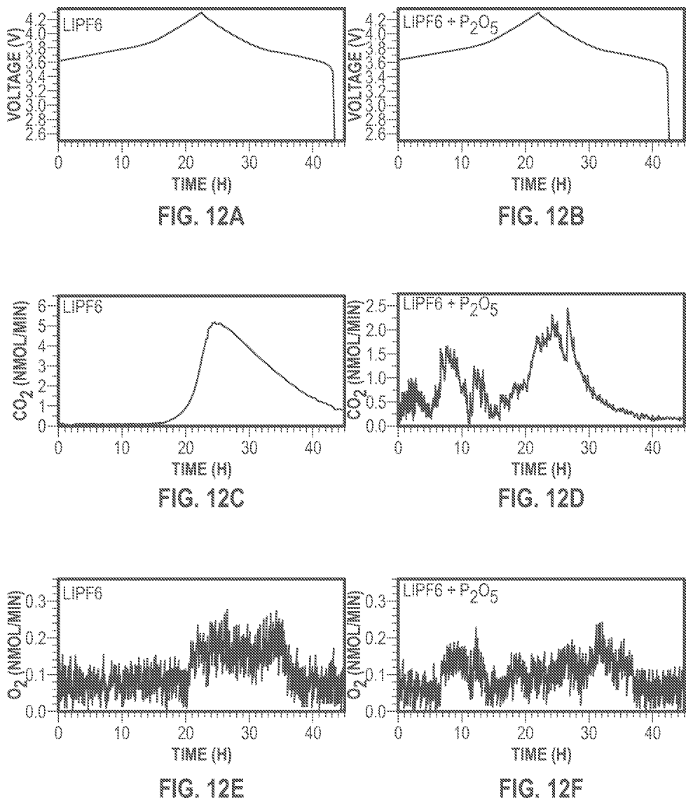

FIGS. 12A to 12F depict gas analysis using DEMS. FIGS. 12A and 12B depict charge-discharge curves. FIGS. 12C and 12D depict CO₂ generation rate. FIGS. 12E and 12F depict O₂ generation rate with commercial LiPF₆ electrolyte and the electrolyte modified by P₂O₅.

The terms and expressions that have been employed are used as terms of description and not of limitation, and there is no intention in the use of such terms and expressions of excluding any equivalents of the features shown and described or portions thereof, but it is recognized that various modifications are possible within the scope of the examples of the present disclosure. Thus, it should be understood that although the present disclosure has been specifically disclosed by specific examples and optional features, modification and variation of the concepts herein disclosed may be resorted to by those of ordinary skill in the art, and that such modifications and variations are considered to be within the scope of examples of the present disclosure.

### ADDITIONAL EXAMPLES

The following exemplary examples are provided, the numbering of which is not to be construed as designating levels of importance:

Example 1 is a battery cell comprising: an anode comprising lithium metal; a cathode; an electrolyte with an additive comprising phosphorous pentoxide (P₂O₅).

In Example 2, the subject matter of Example 1 optionally includes wherein the anode comprises lithium metal foil.

In Example 3, the subject matter of Example 2 optionally includes 50 m or less.

In Example 4, the subject matter of any one or more of Examples 2-3 optionally include wherein the anode comprises a copper foil sandwiched with two pieces of lithium metal foil.

In Example 5, the subject matter of Example 4 optionally wherein the copper foil comprises 9 m in thickness, and the two pieces of lithium metal foil comprise about 50 m in thickness each.

In Example 6, the subject matter of any one or more of Examples 1-5 optionally include wherein the anode comprises Li—MnO₂, Li—(CF)ₓ, Li—FeS₂, Li—SOCl₂, Li—SOCl₂, BrCl, Li—BCX, Li—SO₂Cl₂, Li—SO₂, Li—I₂, Li—Ag₂CrO₄, Li—Ag₂V₄O₁₁, Li—SVO, Li—CSVO, Li—CuO, Li—Cu₄O(PO₄)₂, Li—CuS, Li—PbCuS, Li—FeS, Li—Bi₂Pb₂O₅, Li—Bi₂O₃, Li—V₂O₅, Li—CuCl₂, Li/Al—MnO₂, Li/Al—V₂O₅, Li—Se, Li-air, Li—FePO₄, or combinations thereof.

In Example 7, the subject matter of any one or more of Examples 1-6 optionally include wherein the cathode comprises a high nickel cathode.

In Example 8, the subject matter of Example 7 optionally includes wherein the cathode comprises an NMC.

In Example 9, the subject matter of any one or more of Examples 1-8 optionally include wherein the cathode comprises a slurry of NMC622, carbon black, and polyvinylidene fluoride in N-Methyl-2-pyrrolidone slurry coated on a current collector.

In Example 10, the subject matter of any one or more of Examples 1-9 optionally include wherein the cathode comprises heat-treated manganese dioxide, carbon monofluoride, iron disulfide, thionyl chloride, thionyl chloride with bromine chloride, sulfur dioxide on Teflon®-bonded carbon, iodine that has been mixed and heated with poly-2-vinylpyridine (P2VP) to form a solid organic charge transfer complex, silver chromate, silver oxide and vanadium pentoxide, copper (II) oxide, copper oxyphosphate, copper sulfide, lead sulfide and copper sulfide, iron sulfide, lead bismuthate, bismuth trioxide, vanadium pentoxide, copper chloride, manganese dioxide, vanadium pentoxide, selenium, porous carbon, lithium iron phosphate, or combinations thereof.

In Example 11, the subject matter of Example 10 optionally includes wherein the slurry is coated in a 300 μm film.

In Example 12, the subject matter of any one or more of Examples 10-11 optionally include wherein the cathode comprises NMC622.

In Example 13, the subject matter of any one or more of Examples 1-12 optionally include wherein each of the anode and the cathode comprises a thickness of about 90 m or less.

In Example 14, the subject matter of any one or more of Examples 1-13 optionally include wherein the electrolyte comprises lithium hexafluorophosphate (LiPF₆).

In Example 15, the subject matter of any one or more of Examples 1-14 optionally include wherein the electrolyte comprises lithium perchlorate, lithium tetrafluoroborate, lithium tetrachloroaluminate, lithium bromide, lithium iodide, lithium perchlorate, lithium hexafluorophosphate, lithium hexafluoroarsenate, lithium perchlorate, lithium salt, or combinations thereof.

In Example 16, the subject matter of any one or more of Examples 1-15 optionally include wherein the electrolyte is in a solvent selected from the group consisting of propylene carbonate, dimethoxyethane, propylene carbonate, dimethoxyethane, gamma-butyrolactone, propylene carbonate, dioxolane, dimethoxyethane, thionyl chloride, sulfuryl chloride, sulfur dioxide, acetonitrile, dioxolane, or combinations thereof.

In Example 17, the subject matter of any one or more of Examples 1-16 optionally include wherein the electrolyte comprises LiPF₆ in organic carbonate solvents with brimstone additives.

In Example 18, the subject matter of any one or more of Examples 1-17 optionally include wherein the electrolyte comprises brimstone composite polymer electrolytes.

In Example 19, the subject matter of any one or more of Examples 1-18 optionally include wherein the electrolyte comprises 1M LiPF₆.

In Example 20, the subject matter of any one or more of Examples 1-19 optionally include wherein the P₂O₅ additive comprises about 5 wt. % of the electrolyte.

In Example 21, the subject matter of any one or more of Examples 1-20 optionally include wherein the battery cell comprises a coin cell.

In Example 22, the subject matter of any one or more of Examples 1-21 optionally include wherein the battery cell comprises a pouch cell.

In Example 23, the subject matter of any one or more of Examples 1-22 optionally include wherein the battery cell comprises about 3 g An-1 electrolyte and additive.

In Example 24, the subject matter of any one or more of Examples 1-23 optionally include wherein the battery cell has a specific capacity of at least about 350 Wh/kg.

In Example 25, the subject matter of Example 24 optionally includes wherein the battery cell has a specific capacity of at least about 450 Wh/kg.

In Example 26, the subject matter of any one or more of Examples 1-25 optionally include wherein the battery cell has an energy density of at least about 800 Wh/L.

In Example 27, the subject matter of Example 26 optionally includes wherein the battery cell has an energy density of at least about 850 Wh/L.

In Example 28, the subject matter of any one or more of Examples 1-27 optionally include wherein the electrolyte and the additive form a protective coating on the lithium metal in situ.

In Example 29, the subject matter of any one or more of Examples 1-28 optionally include wherein the electrolyte and the additive induce uniform lithium deposition within the battery cell.

In Example 30, the subject matter of any one or more of Examples 1-29 optionally include wherein the electrolyte and the additive induce dense lithium deposition within the battery cell.

In Example 31, the subject matter of any one or more of Examples 1-30 optionally include wherein the electrolyte and the additive reduce parasitic reactions on the lithium metal anode.

In Example 32, the subject matter of any one or more of Examples 1-31 optionally include wherein the electrolyte and the additive reduce transition metal leaching from the cathode.

In Example 33, the subject matter of any one or more of Examples 1-32 optionally include wherein the electrolyte and additive induce layer-by-layer structure formation on the lithium metal anode.

In Example 34, the subject matter of Example 33 optionally includes wherein the layer-by-layer structure formation comprises layers of lithium metal anode protection layers and cathode-compatible polymeric lithium ion conducting layers.

In Example 35, The battery cell of Example 1, wherein the electrolyte and additive provide mechanical support to the lithium metal anode.

In Example 36, the subject matter of any one or more of Examples 1-34 optionally include wherein the battery cell is nonflammable.

In Example 37, the subject matter of any one or more of Examples 1-36 optionally include wherein the redox peaks for battery cell do not shift upon galvanostatic cycling.

In Example 38, the subject matter of any one or more of Examples 1-37 optionally include wherein hydrofluoric acid is not a degradation product in the battery cell during operation.

In Example 39, the subject matter of any one or more of Examples 1-38 optionally include wherein pitting on the lithium metal anode during operation is reduced.

In Example 40, the subject matter of any one or more of Examples 1-39 optionally include wherein the intensity of organic SEI components in the cell during operation is reduced.

In Example 41, the subject matter of any one or more of Examples 1-40 optionally include cycles.

In Example 42, the subject matter of Example 41 optionally includes 200 cycles.

In Example 43, the subject matter of any one or more of Examples 1-42 optionally include wherein resistance of the cathode remains substantially steady during cycling.

In Example 44, the subject matter of any one or more of Examples 1-43 optionally include wherein the Rᵢₙₜ of the battery cell remains substantially steady during cycling.

In Example 45, the subject matter of any one or more of Examples 1-44 optionally include wherein the Rᵢₙₜ of the battery cell comprises about 40 to 50 ohms after 30 cycles.

In Example 46, the subject matter of any one or more of Examples 1-45 optionally include wherein the Rᵢₙₜ of the battery cell comprises about 47 ohms after 30 cycles.

In Example 47, the subject matter of any one or more of Examples 1-46 optionally include wherein the R_{ct} of the battery cell remains substantially steady during cycling.

In Example 48, the subject matter of Example 47 optionally includes wherein the R_{ct} of the battery cell comprises about 90 to 100 ohms after 30 cycles.

In Example 49, the subject matter of Example 48 optionally includes wherein the R_{ct} of the battery cell comprises about 98 ohms after 30 cycles.

In Example 50, the subject matter of any one or more of Examples 1-49 optionally include wherein the ratio of DEC:EC is about 0.37:1.0.

In Example 51, the subject matter of any one or more of Examples 1-50 optionally include wherein Mn, Co and Ni species are absent in the EDS spectrum of the lithium metal anode after 30 cycles.

In Example 52, the subject matter of any one or more of Examples 1-50 optionally include wherein the lithium metal anode does not substantially crack during cycling.

Example 53 is an electrolyte for a battery cell, the electrolyte comprising lithium hexafluorophosphate (LiPF₆) and phosphorous pentoxide (P₂O₅).

In Example 54, the subject matter of Example 53 optionally includes wherein the electrolyte comprises about 2-8 wt. % P₂O₅.

In Example 55, the subject matter of Example 54 optionally includes wherein the electrolyte comprises about 4-6 wt. % P₂O₅.

In Example 56, the subject matter of any one or more of Examples 53-55 optionally include wherein the electrolyte comprises about 5 wt. % P₂O₅.

What is claimed is:

1. A battery cell comprising:
an anode comprising lithium metal;
a cathode; and
an electrolyte with an additive comprising phosphorous pentoxide (P₂O₅).

2. The battery cell of claim 1, wherein the anode comprises lithium metal foil having a thickness of about 50 m or less.

3. The battery cell of claim 1, wherein the cathode comprises an NMC.

4. The battery cell of claim 1, wherein the electrolyte comprises lithium hexafluorophosphate (LiPF₆).

5. The battery cell of claim 1, wherein the P₂O₅ additive comprises about 5 wt. % of the electrolyte.

6. The battery cell of claim 1, wherein the battery cell has a specific capacity of at least about 350 Wh/kg.

7. The battery cell of claim 1, wherein the battery cell has an energy density of at least about 800 Wh/L.

8. The battery cell of claim 1, wherein the electrolyte and the additive form a protective coating on the lithium metal in situ.

9. The battery cell of claim 1, wherein the electrolyte and the additive induce uniform lithium deposition within the battery cell.

10. The battery cell of claim 1, wherein the electrolyte and the additive induce dense lithium deposition within the battery cell.

11. The battery cell of claim 1, wherein the electrolyte and the additive reduce parasitic reactions on the lithium metal anode.

12. The battery cell of claim 1, wherein the electrolyte and additive reduce transition metal leaching from the cathode.

13. The battery cell of claim 1, wherein the electrolyte and additive induce layer-by-layer structure formation on the lithium metal anode.

14. The battery cell of claim 1, wherein the electrolyte and additive provide mechanical support to the lithium metal anode.

15. The battery cell of claim 1, wherein the battery cell is nonflammable.

16. The battery cell of claim 1, wherein hydrofluoric acid is not a degradation product in the battery cell during operation.

17. The battery cell of claim 1, wherein pitting on the lithium metal anode during operation is reduced.

18. The battery cell of claim 1, wherein life cycle of the battery cell comprises at least 200 cycles.

19. An electrolyte for a battery cell, the electrolyte comprising lithium hexafluorophosphate (LiPF₆) and phosphorous pentoxide (P₂O₅).

20. The electrolyte of claim 19, wherein the electrolyte comprises about 5 wt. % P₂O₅.
